(19) United States
(12) Patent Application Publication
(10) Pub. No.: US 2004/0091647 A1
(43) Pub. Date: May 13, 2004

(54) Method for making direct marketing composite materials and barcode for composite materials

(76) Inventors: Matthew Thomas Adams, Mason, OH (US); Glenn David Aspenns, Cincinnati, OH (US)

Correspondence Address: ORUM & ROTH, 53 W. JACKSON BLVD, CHICAGO, IL, 60604, US

(21) Appl. No.: 10/622,559

(22) Filed: Jul. 18, 2003

Related U.S. Application Data
(60) Provisional application No. 60/397,457, filed on Jul. 18, 2002.

(51) Int. Cl. B27N 3/10

(52) U.S. Cl. 428/32.16; 264/132; 264/257

(57) ABSTRACT

An integral label for composite materials. The label, printed with magnetically doped ink, may be embedded between layers of a composite during manufacture. The label may be embedded on the surface of the composite material using a heat curable resin. The indicia on the label can be read with magnetic ink character recognition (MICR) or other magnetic scanning technology. There is no need for visual contrast between the composite, label and/or indicia.

### SPECIFICATION

This application claims the benefit of U.S. Provisional Application No. 60/397457 filed Jul. 18, 2002 and incorporated herein in its entirety.

### FIELD OF THE INVENTION

This invention relates to embedded labels and barcodes. Specifically, this invention relates to embedded labels and barcodes for composite materials using mesh material printed with magnetically doped ink.

### DESCRIPTION OF RELATED ART

Direct marking of composite materials such as Kevlar, fiberglass, carbon fiber, etc. is difficult for several reasons. First, the data carrier must be very thin and porous to avoid affecting the functionality of the part to be marked. Second, the data carrier must be relatively simple to use. Third, in many applications the color of the embedded data carrier must blend into the color of the part. Light colored carriers or indicia are not desirable on a dark composite for these applications. Further, high contrast between the indicia and/or carrier and the composite is not desired.

This invention eliminates the problems that existing data carriers have with these issues.

One prior art method of making composites is to embed printed fabric into light colored composite materials as a means of marking them for identification purposes. This process involves the encapsulation of a white typewriter-printed fabric within a heat-curable resin on the surface of the item being marked. This method of marking items requires a visible marker, something that is undesirable in some applications. Further, because the method requires a visible marker it does not provide a means of marking dark-colored composite materials such as graphite, Kevlar, and carbon fiber.

### SUMMARY OF THE INVENTION

This invention will provide a means of creating a magnetic image that is decoded by a magnetic scanning device. Technology has been developed that is capable of decoding machine-readable indicia, codes, and/or symbols that are magnetically charged, even through non-metallic visual obstructions. This technology is used for the marking of composite parts using an embedding process.

There is a need for a means of directly marking dark colored composite materials. Accordingly, one object of the present invention is to provide a method for direct marking of dark colored composite materials, such as Keviar, fiberglass, and carbon fiber. There is also a need for a means of marking composite materials for identification that will not effect the functionality of the part. Accordingly, it is another object of the present invention to provide a means for marking composite material that does not effect the functionality of the part and which is simple to use.

There is a need for a means of marking composite materials for identification in which the identifying marker is hidden or invisible. This is useful for security, national defense, or other similar uses. Accordingly, it is an object of the present invention to provide a means for marking composite materials for identification in which the marker is hidden or invisible.

### BRIEF DESCRIPTION OF THE DRAWINGS

FIG. 1 is a schematic representation of an expanded cross section of a composite material with an embedded barcode.

FIG. 2 is a schematic representation of an expanded cross section of a composite material with an alternative embodiment of the present invention.

FIG. 3 is a cut-away view of a container with an alternative embodiment of the present invention.

FIG. 4 is a cut-away view of a container with an object with an integral label.

### DETAILED DESCRIPTION OF THE INVENTION

Magnetic ink character recognition (MICR), uses a reader that can discern characters printed onto non-magnetic materials using magnetic ink in much the same manner as optical character recognition (OCR) scanners use contrast between the black image and the white paper to discern the characters. MICR is used to print the account numbers on the bottom of checks to make them easily scanned. Similar magnetic imaging technology will allow persons to scan machine-readable bar codes. This ability to use non-optical means for identification solves issues related to marking dark-colored composite materials. Because the scanners read the magnetized ink there is no need for any visual contrast between the ink, carrier and/or object. On dark colored composites, a dark colored carrier with dark indicia is often preferred to minimize or eliminate any visible marks indicating a label.

This present invention involves the printing of a porous woven mesh with ink that has magnetic components incorporated into it. These magnetic components are visible to the scanners, in much the same way as a MICR scanner scans the account numbers on checks. The mesh works for embedding because it is thin and porous, allowing surrounding composite material to flow into the pores and bond with the mesh.

Composite materials are typically formed from at least one reinforcing material and a matrix. The reinforcing material may be, for example, fiber, particulate, or a laminate. Matrix materials may be, for example, ceramic or polymers. Through the selection of variables such as reinforcing material(s), matrix material, composition and reinforcement arrangement composites with a wide range of properties have been developed. Common composite materials are glass-polymer, graphite-polymer, kevlar-epoxy, kevlar-polyester and carbon-carbon composites. Polymer and ceramic matrix composites are widely used, for example, in automotive, marine, aircraft, and aerospace components. They are also used in sporting goods, such as tennis rackets, skis, and fishing rods.

The present invention uses magnetic ink. Because the ink is easily magnetizeable it is preferable that the composite be made of a non-magnetic matrix and non-magnetic reinforcement material.

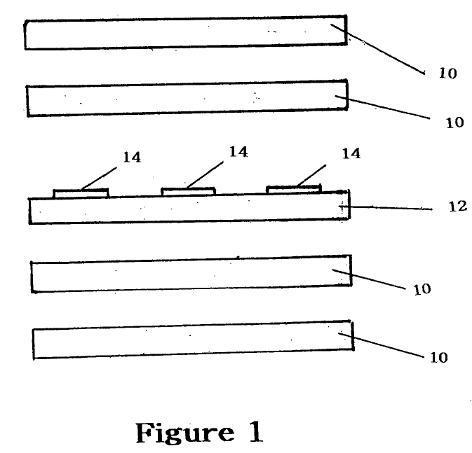

Referring to FIG. 1 a composite material with an embedded barcode is shown. The composite material consists of a plurality of layers of composite material 10. Sandwiched between two of the layers of composite material 10 is a data carrier 12. Indicia 14 is printed on one surface of the data carrier 12. Preferably, the printed indicia 14 is printed using magnetically doped ink. Preferably, the data carrier 12 is a mesh. More preferably, the data carrier 12 is porous woven mesh. Most preferably, the data carrier 12 is a porous woven mesh that is very thin and porous. The porous woven mesh allows the matrix material of the composite material 10 to flow into the fabric thus bonding the wet mesh with the composite material 10.

The mesh is printed with the appropriate indicia 14. The indicia 14 may be any suitable text, a symbol, bar code or other indication. In the preferred embodiment of the present invention, the indicia 14 is a bar code. The indicia 14 is printed using an ink that has magnetic characteristics. In the preferred embodiment, the indicia 14 is printed with magnetically doped ink. The indicia need not have any visible contrast with the mesh and/or composite.

The mesh is embedded between layers of composite material 10. Typically, a product made of composite material 10 such as Kevlar, carbon fiber and fiberglass is manufactured by laminating a plurality of layers of the composite material 10 together. The data carrier is sandwiched between layers of composite material 10. The data carrier 12 is embedded between the layers of a composite material 10 during construction of the product. When the construction is completed, a scanner using MICR or similar technology is able to read the label through the composite material 10. Since the scanner only discerns the magnetic ink, the multiple layers of composite material 10 between the scanner and the data carrier 12 appear invisible to the scanner. Furthermore, the embedded data carrier 12 will not result in any visually discernable marks, effectively concealing the data and its location.

By way of one example, the nose cone of a jet aircraft is manufactured from carbon fiber that is black in color. The cone is manufactured by laminating many sheets of carbon fiber on top of one another resulting in a cone with extremely high strength properties. Porous woven mesh is printed with an identification marker using magnetically doped ink. During construction of the cone, the printed mesh is placed between two of the carbon fiber sheets used to construct the cone. The printed mesh, located between two of the carbon fiber sheets, is constructed into the cone. The marker is read through the cone.

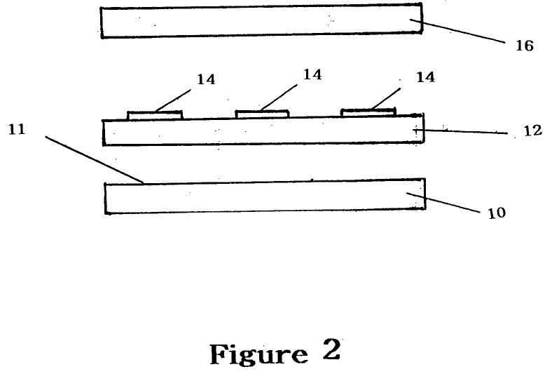

Referring to FIG. 2, another embodiment of the present invention is shown. The printed mesh 12 will be embedded in or on the surface 11 of the composite 10 using a heat-curable, resin material. The composite material 10 can be particulate, laminar, chopped fiber, unidirectional or other known composite type. The resin material 16 is preferably selected based on the composite. The preferred resin material is a heat-curable resin. Preferably, the data carrier 12 with printed indicia 14 is placed on the composite 10 during the manufacturing process and the mesh carrier is coated with the heat curable resin 16. Alternatively, the mesh carrier 12 is placed on the composite 10 after the composite has been manufactured. The resin 16 is then coated over the mesh 10.

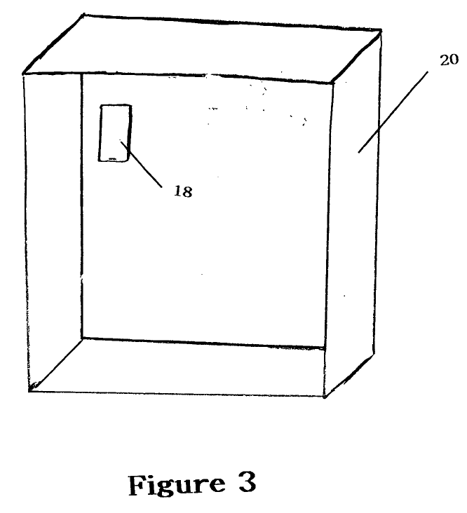

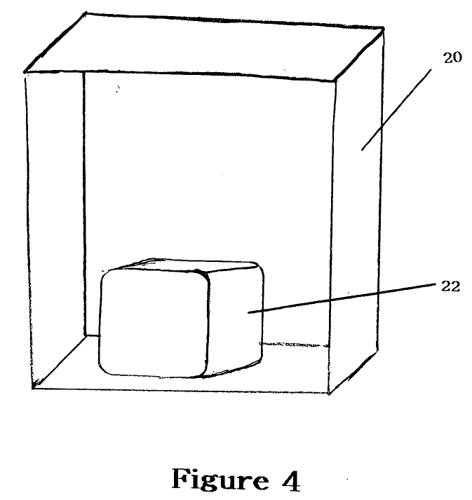

Referring now to FIG. 3, another embodiment of the present invention is shown. A standard label 18 is printed using ink with magnetic characteristics, preferably, magnetically doped ink. The printed label 18 maybe placed on the inside of the container 18 and sealed within the container 22. The indicia does not need to have any visual contrast with the label. It may be desirable in some situations to have visual contrast, so that the label can be read using other methods such as by a person or OCR scanner once the container is opened or before it is closed. As shown in FIG. 4, a composite object 22 such as a automotive, aerospace, marine, or aircraft part, having an integral label can be placed inside a container 20. The label can read through the container 22 wall.

1. A label for use with a composite material comprising:
a carrier with magnetically doped ink indicia, wherein the label is integral with an object comprised of a composite material.

2. The label of claim 1, wherein the label is placed between a first layer and second layer of the composite.

3. The label of claim 1, wherein the carrier is a mesh.

4. The label of claim 1, wherein the carrier is a porous woven mesh and a matrix of the composite impregnates the mesh.

5. The label of claim 1, wherein the object is free of any visually discernable marks indicating the label.

6. The label of claim 2, wherein the object is selected from the group consisting of:
automotive component, aerospace component, marine component, and aircraft component.

7. The label of claim 1, wherein the label is embedded in the surface of the composite material using a resin material.

8. The label of claim 7, wherein the resin is a heat curable resin.

9. The label of claim 7, wherein the carrier is a mesh.

10. The label of claim 7, wherein the carrier is a porous woven mesh and the resin impregnates the mesh.

11. The label of claim 5, wherein the object is free of any visually discernable marks indicating the label.

12. The label of claim 7, wherein the object is selected from the group comprising:
automotive component, aerospace component, marine component, and aircraft component.

13. A label of claim 1 wherein the label is located on the inside of a closed container.

14. A label of claim 13 wherein the label is integral with an object in the container.

15. The method of claim 14 wherein the object is selected from the group consisting of:
automotive component, aerospace component, marine component, and aircraft component.

16. A method of concealing data comprising the steps of:
obtaining a porous mesh carrier;
printing data on the carrier with magnetically doped ink; and
embedding the carrier into a composite material.

17. The method of claim 16, further comprising the steps of:
sandwiching the carrier between a first and second layer of the composite;
allowing a matrix of the composite material to flow into the mesh; and
bonding the mesh to the composite material,
while an object is being manufactured of the composite material.

18. The method of claim 17 wherein the object is selected from the group consisting of:
automotive component, aerospace component, marine component, and aircraft component.

19. The method of claim 16 further comprising the steps of:
placing the carrier on the surface of the composite;
coating the carrier with a resin;
allowing the resin to flow into the mesh;
bonding the mesh to the composite material, and
manufacturing an object from the composite.

20. The method of claim 19, wherein the object is selected from the group consisting of:
automotive component, aerospace component, marine component, and aircraft component.
